(19) United States
(12) Patent Application Publication
(10) Pub. No.: US 2025/0065486 A1
(43) Pub. Date: Feb. 27, 2025

(54) Accessory mount for a electric drill

(71) Applicant: Jason W. Bethards, Granbury, TX (US)

(72) Inventor: Jason W. Bethards, Granbury, TX (US)

(21) Appl. No.: 18/445,452

(22) Filed: Aug. 22, 2023

(51) Int. Cl. B25F 5/02; F16M 13/02

(52) U.S. Cl. CPC B25F 5/02; F16M 13/02

(57) ABSTRACT

Electric drills needs a spot to attach accessories to. Adding a light or a magnetic tray to a drill would make working easier. The light on a drill is small so adding accessories to a drill is important. There is no spot to add accessories on a drill. To add accessories to a drill, a mount will have to be installed. A piece of metal will be attached the motor of the drill. The placement of this mount will be on the top of the drill towards the back. The mount will be shaped in a way that another piece of metal will be able to slide into its grooves to lock in place. This will allow the two mounts to slide together and lock. The mount is designed too slide on from the back and then stop when it is slid together. Looking at the mount from the top looks square. This keeps the accessory from spinning left to right. It will keep the accessory straight. Adding this new mount solves the problems of using different accessories quick and easy on a drill. Its also a safer way to mount accessories because its designed to hold them.

### CROSS-REFERENCE TO RELATED APPLICATIONS

Inventor Jay V Gillette patent number U.S. Pat. No. 6,729,743B2 invented a flashlight accessory for a drill. He made it attach to the bit holder on a drill. Not all drills have bit holders. The mount I propose will be a universal mount made to mount accessories. Snapping a accessory on the bit holder like Gillette is not safe as the holder was not designed to hold anything other then a small bit.

Inventor Judy Lee patent number U.S. Pat. No. 5,954,458A invented a flashlight built into a drill. The difference with Judy and I is my mount is made to take accessories off and on easy and fast. You will also be able to use other accessories also like Magnetic Trays.

### BRIEF SUMMARY OF INVENTION

Adding accessories to an electric hand drill will make working easier. Adding a big light to an electric drill or a magnetic tray would make it easier and safer to work. As of now there is not a spot on a drill to accept accessories. The lights that come on drills are small and don't produce lots of light. Having a universal spot on a drill to add different accessories will be helpful. There are many more accessories that can be added to a drill but there needs to be a mounting location added to the drill so you can attach these accessories. A solid steel mounting lug will be fixed to the motor of an electric drill. This will be the perfect spot to mount because it is the strongest point of the drill. Certain accessories require a mount that will be strong and withstand a load so the mount I'm proposing will have to be mounted to the motor of the drill as this is the only steel in a drill. Plastic is not strong enough to fasten the mount to.

### DESCRIPTION

In the field of power tools, options to add accessories will make working easier and safer. To add many different accessories to an electric drill, a mount will have to be installed so that accessories can be added to a drill as needed and replaced as a different situation arises. The mount with special cuts and groves will be mounted on the top of the drill and in the back of the drill. The lug will be fastened to the motor of the drill as this is the strongest point of the drill and need to utilize strength that an accessory can require. The shape of the lug will allow another accessory to slide into the cut groves and lock into place safely and securely. This will keep the accessory from spinning. The mount will stick out of the drill and be flush with the drill. This will be enough room for an accessory lug to slide on to this lug and hold an accessory.

### BRIEF DESCRIPTION OF THE DRAWINGS

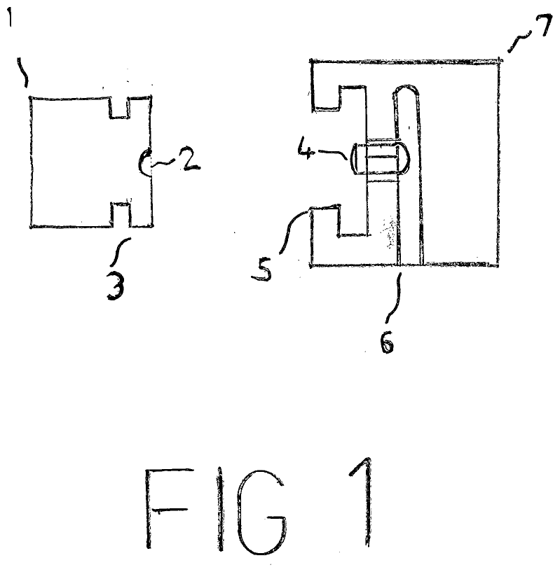

FIG. 1
Number 1. Male Mount that will mount to an accessory.
Number 2. Ball Bearing Indent to lock the Two mounts together.
Number 3. Grove cut to accept female mount to lock together.
Number 4. Ball bearing spring lock.
Number 5. Grove cut to accept male mount and lock the two mounts together.
Number 6. Install hole for ball bearing spring button mount.
Number 7. Female Mount.

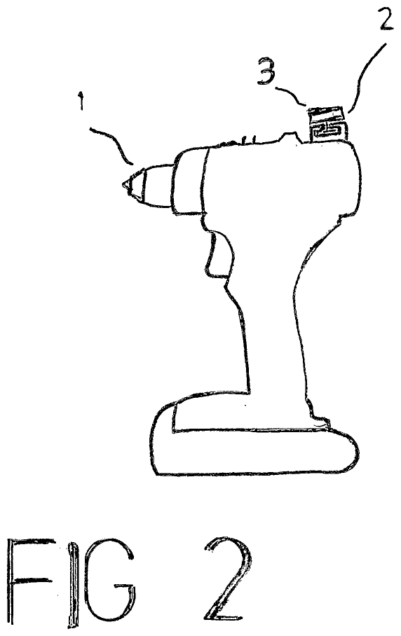

FIG. 2
Number 1. Drill.
Number 2. Male mount connected with the female mount.
Number 3. Female Mount mounted on the drill.

1. A universal attachment point on a hand held electric drill to accept accessories, to add accessories to a drill, would require an attachment point, this consists of a piece of metal that will be attached to the drill permanently, A apparatus made of metal shaped in a way that will allow different accessories to slide and lock into place making the accessory part of the drill, this attachment point will be securely mounted to the drill motor and stick out the top of the drill, the location of the mount is on the back of the drill facing the top, the accessory mount comprises metal that has cuts and groves that allow another piece of metal to slide and lock together to fasten the accessories securely, the other side of the mount will be built in to the drill and fixed to a strong point of the drill to withstand forces an accessory can produce.
